(19) United States
(12) Patent Application Publication
(10) Pub. No.: US 2014/0211612 A1
(43) Pub. Date: Jul. 31, 2014

(54) SETTING UP PRECALCULATED ALTERNATE PATH FOR CIRCUIT FOLLOWING FAILURE IN NETWORK

(71) Applicant: Telefonaktiebolaget L M Ericsson (pulb), Stockholm (SE)

(72) Inventors: Enrico Dutti, Livorno (IT); Francesco Fondelli, Calcinaia (IT); Piero Francione, Pisa (IT)

(21) Appl. No.: 14/119,757

(22) PCT Filed: Jul. 4, 2011
(86) PCT No.: PCT/EP2011/061194

§ 371 Date: Jan. 9, 2014

(30) Foreign Application Priority Data
May 27, 2011 (EP) 11167991.6

(51) Int. Cl. H04L 12/24

(52) U.S. Cl. CPC H04L 41/0654
USPC 370/225

(57) ABSTRACT

A node for a telecommunications network has a switch and a controller, for setting up a circuit along a main path through the network. The circuit associated with one or more precalculated alternate paths, for use in the event of failure of the main path. A check is made of whether one or more of the precalculated alternate paths is currently valid, based on whether the network resources needed by the alternate paths are currently available, according to a local dynamically updated routing database. If valid, then the controller sets up the switch and communicates with other nodes to set up one of the alternate paths for that circuit. This can reduce the chance of rerouting delay caused by the setting up of the alternate path failing owing to its resources no longer being available. Checking the precalculated path is still quicker than calculating an alternate path dynamically when needed.

### TECHNICAL FIELD

This invention relates to nodes for telecommunications networks, and to methods of operating such nodes, and to computer programs for carrying out such methods.

### BACKGROUND

In a typical circuit based (rather than purely packet based) telecommunications network, such as an Automatic Switched Optical Network (ASON), one or more circuits can be rerouted following a fault that causes a traffic disruption. The rerouting is aimed at recovering traffic in the shortest time possible, to limit the amount of lost or disrupted traffic.

Routing and signalling protocols are involved in the rerouting process in such networks and the way these modules interact contribute to the speed of the rerouting process. Other factors are important for the rerouting duration like the hardware capabilities of the equipment but these characteristics cannot be affected by how the ASON protocols interwork.

In an ASON network made of Dense Wavelength Division Multiplex (DWDM) capable Network Elements (NE) a Path Computation Engine is typically be provided centrally. This PCE, interacting with a planning tool, is asked to compute one or more alternate explicit paths for the circuits that must be set up in the network. So the network is built with the appropriate hardware based on a given traffic matrix and the results of the work of the PCE. This PCE works offline as it must interact with the network construction since DWDM network elements do not have the flexibility or the computational power typical of other kind of technologies like SDH or IP; basically each network element is assembled based on the traffic it will have to process.

In an ASON DWDM network each node will be given the list of circuits it has to manage; each circuit will be characterized by a protection mechanism and a set of paths. Every circuit will have one or more main paths to be set up by signalling between nodes, and zero or more alternate paths (also called reserved paths) that the node might try to setup in case of need if the main path fails.

For example a node might have a circuit with one path to be signalled and 20 reserved paths ready to be used in case the first path breaks. The resources of these 20 reserved paths are not used exclusively by this circuit but instead they are shared between multiple circuits, even those originating from other nodes. Thus when a node tries to reroute a circuit by setting up one of these pre-calculated alternate paths, it may be blocked. Even if there is no sharing, in a distributed routing environment, however, the resource information used to pre calculate a constraint-based path may be out of date. This can also result in a setup request for an alternate path being blocked, for example because a link or node along the selected path has insufficient resources. This may delay the rerouting significantly, thus causing more loss of data.

The alternative of dynamically calculating the alternate path at the time it is needed, rather than using a pre-calculated path, is too time consuming for all but the smallest of networks. Currently, the standard way of dealing with the problem is to start setting up the precalculated alternate path and when it fails, have feedback from the network using the signaling procedure, about the location of the failure. The originating node can then react to it accordingly, to set up another alternate path which avoids the location of the failure [called crankback, and described in RFC4920]. This is still unsatisfactory in cases where there are multiple blocked locations or cascading failures if many circuits are being rerouted simultaneously. Only some of these will be flagged to the originating node by such error signalling, which can mean that many alternate paths are tried before one is successful.

### SUMMARY

An object of the invention is to provide improved apparatus or methods. According to a first aspect, the invention provides a node for a telecommunications network, the node having a switch and a controller, the controller being arranged to carry out a set up procedure for setting up a circuit along a main path through nodes of the network. The circuit has associated with it one or more precalculated alternate paths for the circuit, stored so that the controller can set them up in the event of failure of the main path, and the controller is arranged to respond to an indication of failure of the main path for the circuit by causing a check to be made of whether one or more of the precalculated alternate paths is currently valid, based on whether the network resources needed by the one or more alternate paths are currently available, according to a local dynamically updated routing database. The controller is arranged to set up the switch and to communicate with other nodes to set up one of the alternate paths for that circuit based on the outcome of the check.

This can reduce the chance of rerouting delay caused by the setting up of the alternate path failing owing to its resources not being available. Checking the precalculated path is still quicker than calculating an alternate path dynamically when needed, so there can be reduced delay or data loss during re-routing, by avoiding the path calculation. The delays involved in doing a validity check are likely to scale approximately proportionally with the number of nodes. Whereas the delays involved in doing path computation are likely to scale exponentially with the number of nodes.

Another aspect of the invention can involve a corresponding method of operating a node for a telecommunications network, involving setting up a circuit along a main path through nodes of the network, the circuit having one or more precalculated alternate paths for the circuit, stored locally, for use in the event of failure of the main path. The method also involves responding to an indication of failure of the main path for the circuit by causing a check to be made of whether one or more of the precalculated alternate paths is currently valid, based on whether the network resources needed by the one or more alternate paths are currently available, according to a local dynamically updated routing database. Then there is a step of setting up the switch and communicating with other nodes to set up one of the alternate paths for that circuit based on the outcome of the check.

Another aspect of the invention provides a computer program for carrying out the methods. Any additional features can be added to these aspects, or disclaimed from them, and some are described in more detail below. Any of the additional features can be combined together and combined with any of the aspects. Other effects and consequences will be apparent to those skilled in the art, especially over compared to other prior art. Numerous variations and modifications can be made without departing from the claims of the present invention. Therefore, it should be clearly understood that the form of the present invention is illustrative only and is not intended to limit the scope of the present invention.

### BRIEF DESCRIPTION OF THE DRAWINGS

How the present invention may be put into effect will now be described by way of example with reference to the appended drawings, in which:

FIG. 1 shows a schematic view of a node according to an embodiment,

FIG. 2 shows steps of a method of operating a node according to an embodiment,

FIG. 3 shows steps according to another embodiment, where the check is carried out within the node,

FIG. 4 shows another embodiment showing the local routing database being shared by two or more nodes,

FIG. 5 shows another embodiment having a path computation element within the node,

FIG. 6 shows steps of a method using a distributed signaling method to set up an LSP,

FIG. 7 shows another embodiment in the form of an ASON node, having a connection controller for setting up wavelengths,

FIG. 8 shows another embodiment in the form of an SDH node having a connection controller for setting up SDH time slots,

FIG. 9 shows method steps according to another embodiment, showing steps after validity check fails, and

FIG. 10 shows steps of an example of a validity check according to an embodiment.

### DETAILED DESCRIPTION

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes.

Definitions

Where the term “comprising” is used in the present description and claims, it does not exclude other elements or steps. Where an indefinite or definite article is used when referring to a singular noun e.g. “a” or “an”, “the”, this includes a plural of that noun unless something else is specifically stated.

The term “comprising”, used in the claims, should not be interpreted as being restricted to the means listed thereafter; it does not exclude other elements or steps.

Elements or parts of the described nodes or networks may comprise logic encoded in media for performing any kind of information processing. Logic may comprise software encoded in a disk or other computer-readable medium and/or instructions encoded in an application specific integrated circuit (ASIC), field programmable gate array (FPGA), or other processor or hardware.

References to nodes can encompass any kind of switching node, not limited to the types described, not limited to any level of integration, or size or bandwidth or bit rate and so on.

References to a computer program or software can encompass any type of programs in any language executable directly or indirectly on processing hardware.

References to hardware, processing hardware or circuitry can encompass any kind of logic or analog circuitry, integrated to any degree, and not limited to general purpose processors, digital signal processors, ASICs, FPGAs, discrete components or logic and so on.

References to controllers can encompass any kind of controller implemented in hardware or software, in any technology, producing control signals or other outputs, of any format.

References to circuits are intended to encompass connections of any type, defined by an ingress node and an egress node, for carrying a defined subset of the overall data traffic from a given source, such as a particular client. They can be intangible in the sense that they do not need to be tied to a particular physical path or particular physical components.

Abbreviations

ASON Automatic Switched Optical Network

ASTN Automatic Switched Transport Network

DWDM Dense Wavelength Division Multiplexing

GMPLS Generalized MultiProtocol Label Switching

IP Internet Protocol

NE Network Element

OSPF Open Shortest Path First

PC Path Computation

PCE Path Computation Engine

RFC Request For Comments

TE Traffic Engineering

Introduction to Embodiments

By way of introduction to the embodiments, some issues with conventional designs will be explained with reference to network features which can be incorporated into embodiments of the present invention.

In some known networks, there is a control plane made up of controllers at each of the nodes. As is explained in RFC 4920, RSVP-TE (RSVP Extensions for LSP Tunnels) [RFC3209] can be used for establishing paths in the form of explicitly routed LSPs in an MPLS network. Using RSVP-TE, resources can also be reserved along a path to guarantee and/or control QoS for traffic carried on the LSP. To designate an explicit path that satisfies Quality of Service (QoS) guarantees, it is necessary to discern the resources available to each link or node in the network. For the collection of such resource information, routing protocols, such as OSPF and Intermediate System to Intermediate System (IS-IS), can be extended to distribute additional state information [RFC2702].

Explicit paths can be computed based on the distributed information at the LSR (ingress) initiating an LSP and signaled as Explicit Routes during LSP establishment. Explicit Routes may contain ‘loose hops’ and ‘abstract nodes’ that convey routing through a collection of nodes. This mechanism may be used to devolve parts of the path computation to intermediate nodes such as area border LSRs.

A setup request signaling procedure may be blocked, for example because a link or node along the selected path has insufficient resources. In RSVP-TE, a blocked LSP setup may result in a PathErr message sent to the ingress, or a ResvErr sent to the egress (terminator). These messages may result in the LSP setup being abandoned. In Generalized MPLS [RFC3473] the Notify message may additionally be used to expedite notification of failures of existing LSPs to ingress and egress LSRs, responsible for performing protection or restoration. These existing mechanisms provide a certain amount of information about the path of the failed LSP.

Generalized MPLS [RFC3471] and [RFC3473] extends MPLS into networks that manage Layer 2, TDM and lambda resources as well as packet resources. Thus, crankback routing is also useful in GMPLS networks. In a network without wavelength converters, setup requests are likely to be blocked more often than in a conventional MPLS environment because the same wavelength must be allocated at each Optical Cross-Connect on an end-to-end explicit path.

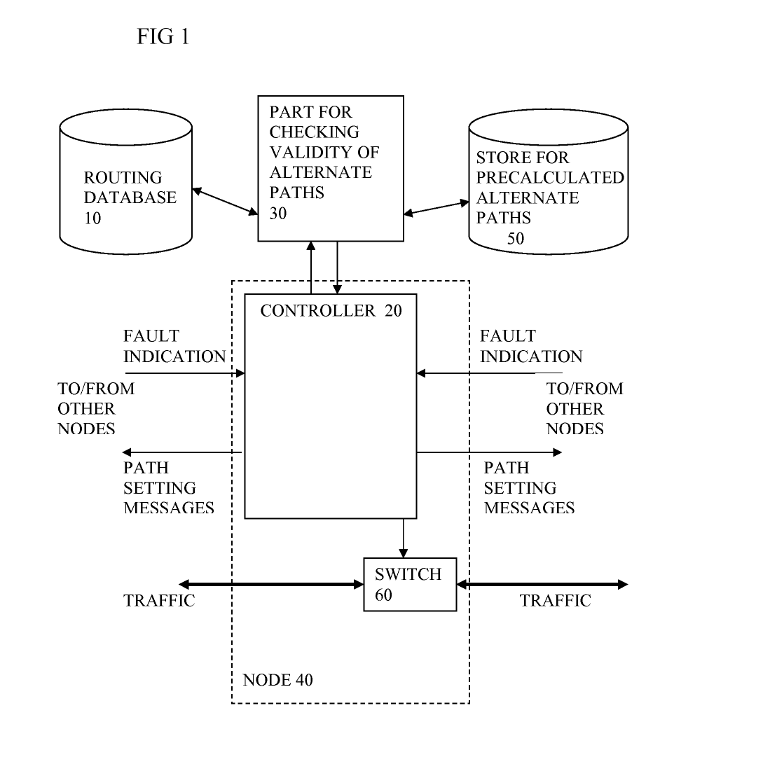

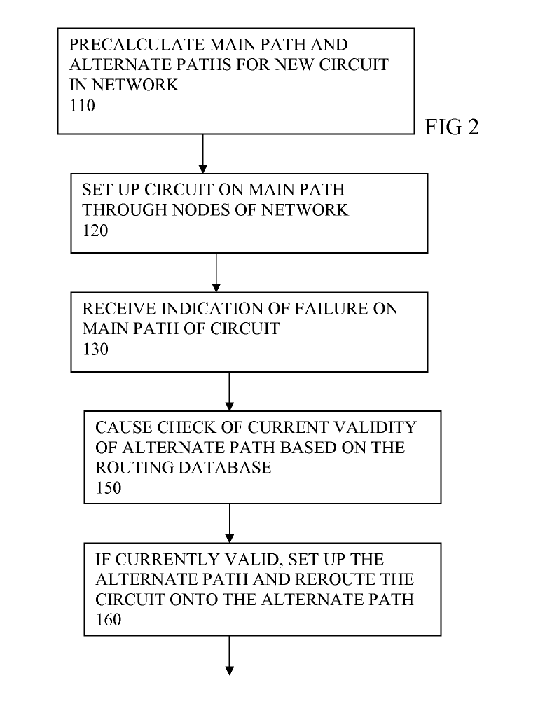

FIGS. 1 and 2, an Embodiment of a Node and Operational Steps,

In this network environment each node will have a database populated by a routing protocol with information about usable resources. This information is updated with a certain delay when any allocation of resources on the network changes. Using this set of information it is possible to understand if a path can be created or it is useless to try to create it because the resources it should use are busy or unavailable. In some embodiments of the invention it is possible to use a path validation mechanism to understand if a path is viable before starting to process it with the signalling protocol in the network. Working in this way it is possible to reduce the amount of failures during signalling, consequently reducing the restoration time and thus reduce traffic disruption. In other words, some embodiments use the information contained in the topology database of an ASON node to predict if the signalling of a pre-computed path can be attempted or is potentially useless or even harmful. The method uses as an input parameter the path that was selected in order to be setup in the network and the network topology, contained in a topology database populated and updated by a routing protocol. It is possible to use the same mechanism even in an ASON network made of TDM cross-connects. In such network it is very important to reroute a certain number of circuits in a time as short as possible. In case of multiple failures the time needed to perform the distributed path computation might be relevant in case of big networks and a high number of circuits impacted by a fault.

In such a scenario it is possible to pre-calculate and store alternate paths before a failure occurs using a low priority process. These candidate paths can be stored and refreshed periodically. When a failure occurs for each circuit the path computation is performed only if the pre-calculated path is not validated correctly.

At least some of the embodiments involve reducing and possibly avoiding signaling failures and thus can be seen as an alternative or as a complementary approach to existing methods. Merely relying on signaling error feedback alone as in RFC 4920 can be unsatisfactory because it is likely to be computationally inefficient and network consuming.

FIG. 1 shows a schematic view of a node 40. A controller 20 is provided coupled to a switch 60 for handling traffic between nodes. The controller can set up paths for circuits by exchanging messages with other nodes and by configuring the switch part 60. This can be any kind of switch, including a time slot based switch, a wavelength switch, a cross connect or an add drop multiplexer and so on. It can receive fault indications from the other nodes. The controller is also coupled to a part 30 for checking the validity of precalculated alternate paths stored in a store 50. These parts can be within the node or external to the node as shown. They should not be located so far from the node that communications delays between them become significant. The controller can select an alternate path for a given circuit, when the controller receives an indication of a failure of the main path for that circuit. The controller can control the part 30 to cause the validity to be checked by the part 30 based on whether the network resources needed by the alternate path is currently available, according to a local dynamically updated routing database 10.

This database can be implemented in various ways. It is typically a database where the routing protocol stores the data received about the network topology and its characteristics. It can in some cases be used to perform path computations and, in this case, path validations. It does not need to differ from a database used by a PCE, it can be the same thing. For the particular technologies used by the network (such as SDH or DWDM) the database would need to be populated with different information. The database can store a representation of the network as a pool of nodes interconnected by links Each node and each link typically has many associated data fields. Part of this information is not related to the technology (for example the source and destination node of each link, the administrative information about each entity) the equipment is based on and another part of the information is related to the technology (free data resources, like SDH timeslots or DWDM lambdas).

The database can be dynamically updated in any way. One example involves discovering the resources available to each link or node in the network using routing protocols, such as OSPF and Intermediate System to Intermediate System (IS-IS), which can be extended to distribute additional state information [RFC2702].

If the validity check is successful, the controller can then carry out the rerouting of the circuit by setting up the alternate path with more confidence that the alternate path is less likely to fail and cause more delay.

FIG. 2 shows operational steps according to an embodiment. At step 110 a main path and alternate paths are precalculated for a new circuit in the network, or for all planned circuits at the outset when the network is commissioned. This is usually computationally intensive and is usually carried out centrally where it is easier to provide the necessary computational resources. At step 120, the circuit is set up on the main path through nodes of the network, typically initiated by the controller on the ingress node. At step 130 the controller later receives an indication of a failure on the main path of the circuit, which could be caused by a hardware fault, a maintenance outage, or a higher priority circuit bumping the existing circuit off some node or link for example. At step 150, the controller causes a check of the validity of the alternate path for that circuit to be carried out, by checking whether the network resources needed by that alternate path, such as links, nodes, regenerators if appropriate, are currently available according to the routing database. If valid, then the next step 160 is to set up the alternate path by passing messages to the specified nodes for example, and then reroute the circuit onto the alternate path.

Additional Features of Embodiments:

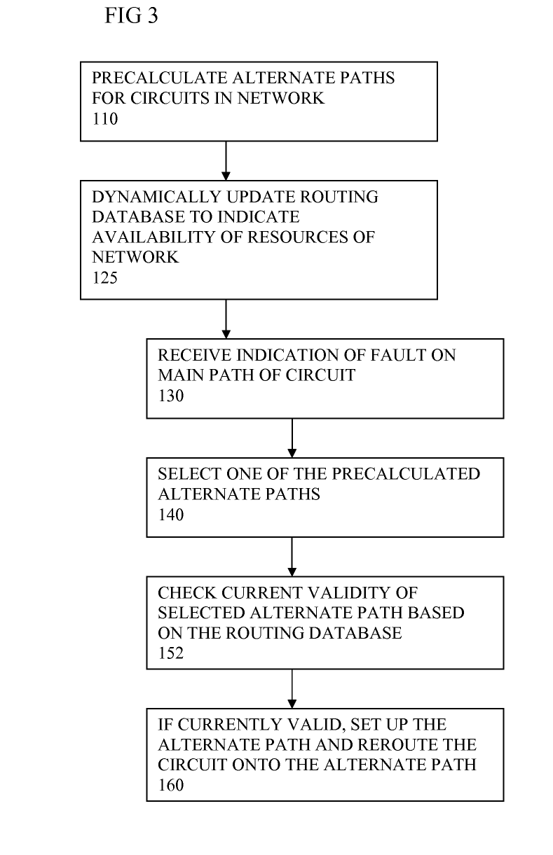

Some possible additional features and their effects are now set out before describing further embodiments incorporating such features with reference to FIGS. 3 onwards. The controller can be arranged to select one of the alternate paths in response to the indication of a failure of the main path, and to carry out the check on the selected alternate path before rerouting the circuit along the selected alternate path. This is shown in FIG. 3. Such selecting first, before checking can be more efficient, and the most up to date information can be used in the check if it is carried out just before the rerouting is needed.

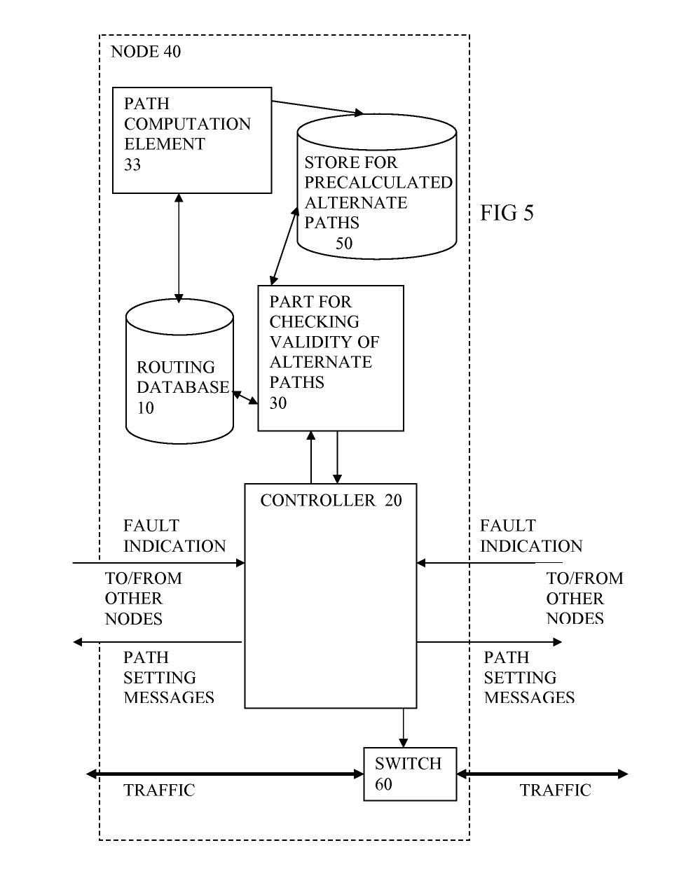

The node can have a path calculation element, for generating the precalculated alternate paths. This is shown in FIG. 5, and as the alternate paths can be generated locally, this can reduce communications overhead with a central entity and enable greater autonomy and resilience of the network.

The node can have the local dynamically updated routing database within the node for indicating current availability of resources of the network, as shown in FIG. 5. This can also mean less delay in accessing the database if it is co-located and can reduce communications overhead, enabling greater autonomy and resilience of the network.

The node can also have the validity checking part within the node, and arranged to access the routing database to carry out the check of the validity as shown again in FIG. 5. Again this can mean less delay in providing the check if it is co-located.

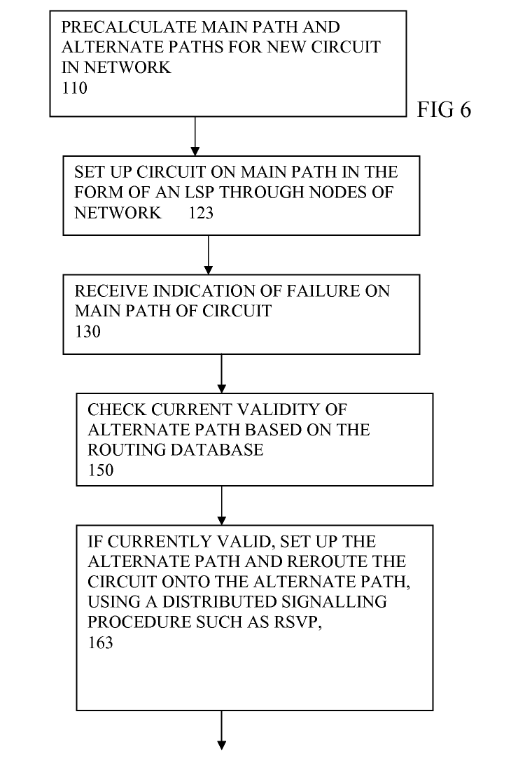

The node can have a protocol controller to carry out the set up procedure using a distributed signalling procedure with neighbouring nodes, as shown in FIG. 6. This type of set up is widely used and so is commercially valuable. It can suffer long delays if rerouting fails, so it is particularly beneficial to apply the validity checking technique to reduce such delays.

The distributed signalling can comprise an RSVP protocol and the circuits can comprise label switched paths. Again this is widely used and can involve long delays if rerouting fails, so it is particularly beneficial to be able to reduce such delays

The node can be a node for an automatically switched optical network, the paths comprising one or more optical paths, and the controller be arranged to carry out the rerouting on an end to end basis. It is intrinsically difficult to do path computation dynamically in distributed fashion at the nodes in such networks, so it is particularly useful to speed up the rerouting without such path computation.

The node can be a node for a synchronous network, and the switch can comprise an electrical domain switch. Such networks are typically more flexible and are widely used. Since they can have many nodes, the path computation can take much time and rerouting delays can be significant, so it is particularly beneficial to be able to reduce such delays.

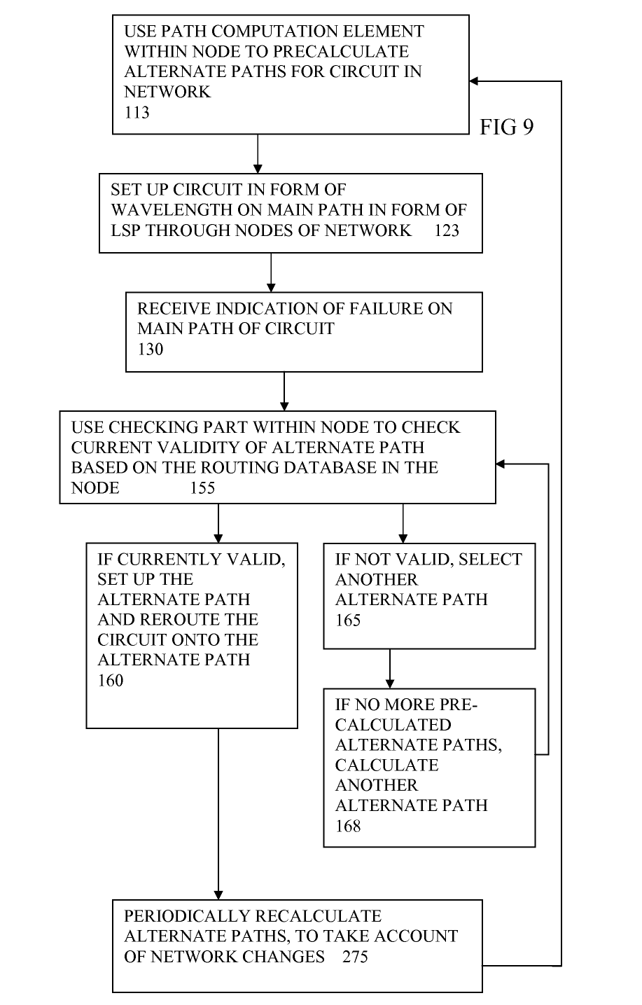

The path computation element can be arranged to recalculate the precalculated alternate paths periodically as shown in FIG. 9. This helps to keep the alternate paths maintained reasonably up to date. This in turn enables rerouting to be carried out after validation without the needing to perform path calculation which can be time consuming.

The path computation element can be arranged to generate a further alternate path if the check indicates that the alternate paths are not currently valid, as shown in FIG. 9. This can enable more attempts to reroute, to avoid disrupted parts of the network not anticipated at the time of precalculating the alternate paths.

It is notable that there is some benefit in using crankback even when the path validity check is carried out, because there is no certainty that if a path validation is correct then the path will be setup in 100% of cases because the routing database is always a little bit out of date and more then one node can try to use the same resources at the same time. So crankback and path validation will work together, in which case the crankback is likely to be used a lot less often then in a system without path validation.

FIG. 3, Another Embodiment, Check is Carried Out Within the Node,

FIG. 3 shows steps according to another embodiment, where the check is carried out within the node. As in FIG. 2, at step 110 a main path and alternate paths are precalculated for a new circuit in the network, or for all planned circuits at the outset when the network is commissioned. At step 125, there is a step of dynamically updating the routing database to indicate availability of resources of the network. This can be an ongoing process repeated regularly. At step 130 the controller later receives an indication of a failure on the main path of the circuit, which could be caused by a hardware fault, a maintenance outage, or a higher priority circuit bumping the existing circuit off some node or link for example. At step 140, one of the precalculated alternate paths is selected. This selection could be according to which is the shortest, or could take account of other factors, such as avoiding bottlenecks in the network, and avoiding the location or vicinity of the failed part if that is known to the node. At step 152, the node carries out a check of the validity of the alternate path for that circuit to be carried out, by checking whether the network resources needed by that alternate path, such as links, nodes, regenerators if appropriate, are currently available according to the routing database. This implies the validity check is carried out within the node, by the controller or by a separate checking part within the node. If valid, then the next step 160 is to set up the alternate path by passing messages to the specified nodes for example, and then reroute the circuit onto the alternate path.

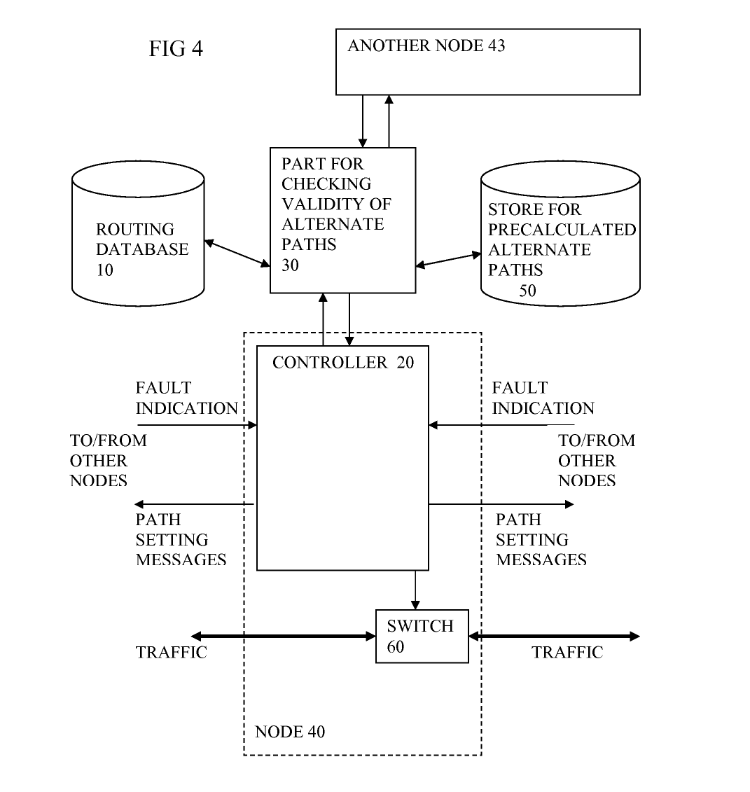

FIG. 4 Another Embodiment, Validity Check Part Shared by Another Node,

FIG. 4 shows another embodiment similar to that of FIG. 1, and showing the local routing database, the part for checking validity, and the store for the precalculated alternate paths, being shared by two or more nodes 40, 43. In other variations, any one or two of these parts can be shared. The interconnections can be also varied, as shown the nodes access the store and the routing database via the part for checking validity, but there could be direct connections between the nodes and all parts. These external shared parts should be located close enough that communications delays do not affect the procedure significantly.

FIG. 5 Embodiment having Path Computation Element Within the Node,

FIG. 5 shows another embodiment having a path computation element 33 within the node, and coupled to the store for the precalculated alternate paths. A variation would be to have a direct connection to the controller from the path computation element. The path computation element is also coupled to the routing database to use the information in that database about the network topology and availability of bandwidth and so on. It is feasible to have a centralized PCE or local PCE at each node, or hybrid arrangements where the local PCE is used only for calculating alternate paths, or only for updating such alternate paths.

FIG. 6, Method Using Distributed Signaling to Set Up an LSP,

FIG. 6 shows steps similar to those of FIG. 3, of a method using a distributed signaling method to set up an LSP. As in FIG. 3, at step 110 a main path and alternate paths are precalculated for a new circuit in the network, or for all planned circuits at the outset when the network is commissioned. At step 123, there is a step of setting up a circuit on the main path in the form of an LSP though nodes of the network. At step 130 the controller later receives an indication of a failure on the main path of the circuit, which could be caused by a hardware fault, a maintenance outage, or a higher priority circuit bumping the existing circuit off some node or link for example. At step 150, the node carries out a check of the validity of the alternate path for that circuit to be carried out, by checking whether the network resources needed by that alternate path, such as links, nodes, regenerators if appropriate, are currently available according to the routing database. If valid, then the next step 163 is to set up the alternate path by passing messages to the specified nodes for example, using a distributed signaling procedure such as RSVP and then reroute the circuit onto the alternate path.

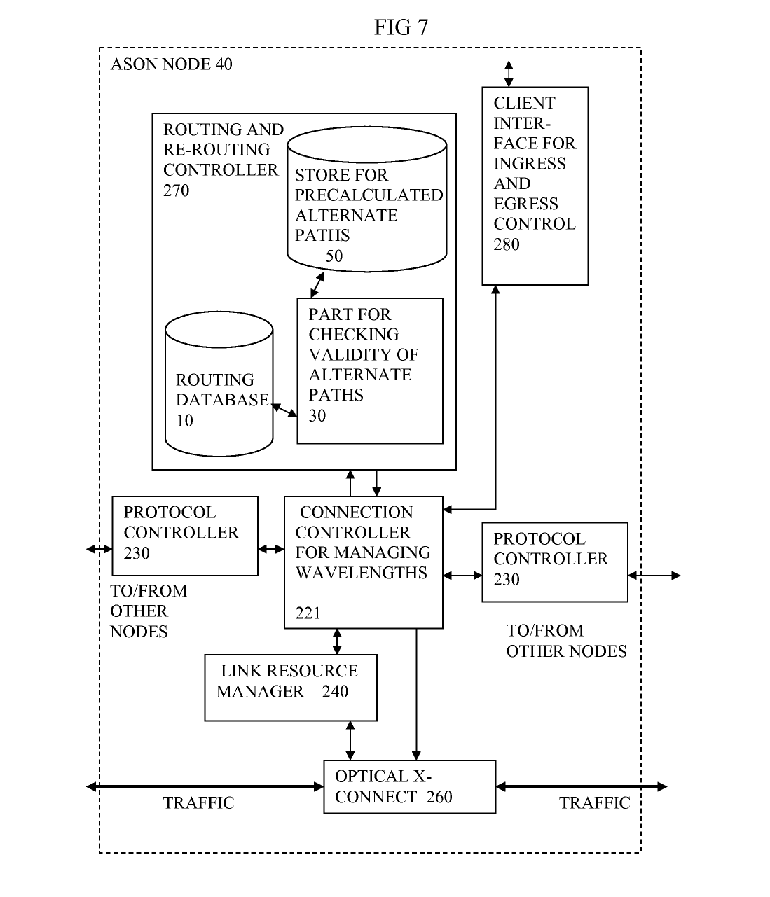

FIG. 7 ASON Node Embodiment, having Controller for Setting Up Wavelengths,

FIG. 7 shows another embodiment in the form of an ASON node, having a connection controller for setting up wavelengths. This embodiment has a controller in the form of a connection controller 221 for managing wavelengths, coupled to configure a switch in the form of an optical cross connect 260. messages for setting up paths can be exchanged with other nodes via protocol controllers 230. A link resource manager 240 is shown coupled to the cross connect for managing individual links The connection controller is also coupled to a client interface 280 for managing ingress and egress of traffic into the network at this node. The routing database 10, the part 30 for checking validity of alternate paths and the store 50 for the precalculated alternate paths are shown as components of a routing and re-routing controller 270 within the node and coupled to the connection controller.

In operation, a request for a new circuit arrives via the client interface 280 with an explicit routing for a main path and an alternate path. The connection controller tries to set up the main path using the protocol controllers and stores the alternate path in the store 50. If a failure indication is received for the main path from other nodes along the path, via the protocol controllers, then the connection controller requests an alternate path from the routing and re-routing controller. A validity check is carried out by the part 30, within the routing and re-routing controller.

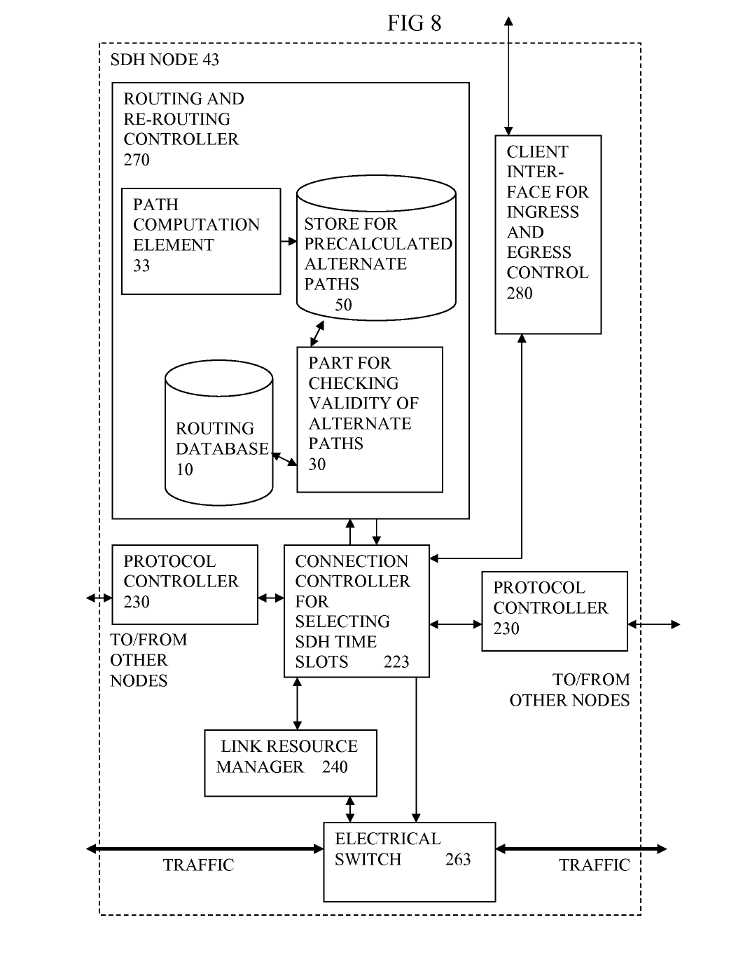

FIG. 8 SDH Node Embodiment having Controller for Setting Up SDH Time Slots,

FIG. 8 shows another embodiment similar to that of FIG. 7 but in the form of an SDH node having a controller in the form of a connection controller 223 for setting up SDH time slots. The switch is in the form of an electrical switch 263, which may have electrical or optical links to other nodes. As there is more flexibility in such networks, the path computation is less complex for a given size of network.

FIG. 9 Method Steps According to Another Embodiment, Showing Steps After Validity Check Fails,

FIG. 9 shows steps similar to those of FIG. 4, for a node having a path computation element within the node, and further steps explaining actions after a validity check fails. At step 113 the path computation element is used to precalculate alternate paths for circuits in the network. This is typically done just for the circuits which are managed at this node, usually circuits for which this node is the ingress node. At step 123, the circuit is set up in the form of a wavelength on part or all of the main path, which is an LSP in this case. At step 130, an indication of a failure of the main path of a particular circuit is received by the node. An alternate path is selected and at step 155 a checking part within the node is used to check the current validity of this alternate path, based on the information in the routing database within the node.

If valid, then the next step 160 is to set up the alternate path by passing messages to the specified nodes for example, and then reroute the circuit onto the alternate path. After this the process awaits another indication of a failure or awaits a new request for a circuit. Periodically the alternate paths can be recalculated, to update them to take account of any changes in the network, shown by step 275. If not valid, then at step 165 another alternate path is selected and the process repeats step 155 of checking the validity. If there are no more precalculated alternate paths, then at step 168, a path calculation step is carried out to calculate another alternate path, based on the information about availability of links and nodes in the routing database.

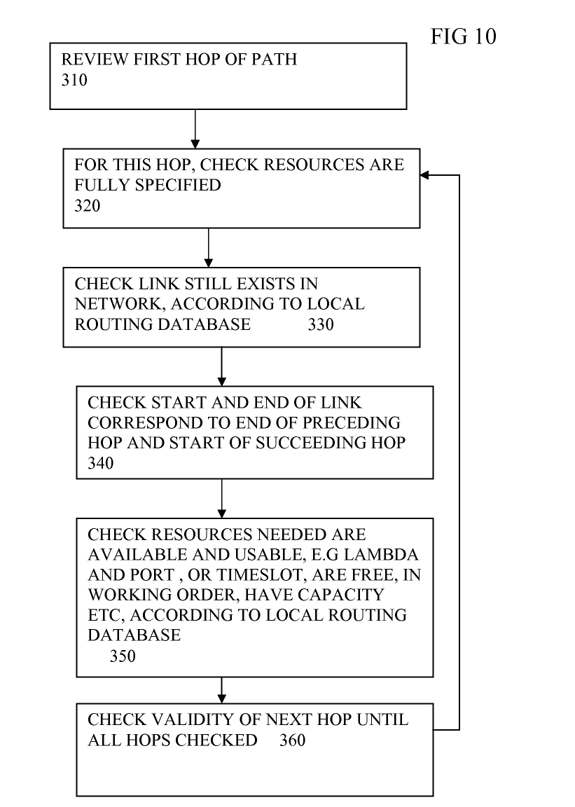

FIG. 10 Example of a Validity Check According to an Embodiment

FIG. 10 shows steps of an example of a validity check according to an embodiment. These steps can be carries out by the part 30 for checking the validity. Other examples and variations can be envisaged. Any given path is made of a certain number of Hops (1 to N); each Hop identifies a physical resource on a network using a set of data. The node running the path validation method will check, for each Hop in the path, if the resource is free and if the path is composed correctly.

A general example of a path validation mechanism is as follows:

In FIG. 10, a first step 310 is to review a first hop of the path.

for each Hop in position X (HopX) in the path verify that:
HopX has all the needed information to identify univocally the resources it needs (i.e. HopX is syntactically correct) as shown by step 320 in FIG. 10
Check link still exists in network according to local routing database, as shown by step 330
HopX is linked to NodeX that was reached by Hop X−1 (Hop1 must start from Node0 that is the ingress node of the path) see step 340, check start of link corresponds to end of previous link, and that HopX reaches NodeX+1 that is present in the topology database, see step 340, checking that end of link corresponds to start of next link
HopX uses resources on a link between NodeX and NodeX+1 that are available, see step 350, check resources needed are available and usable, e.g lambda and port, or timeslot, are free, in working order, have capacity etc, according to local routing database.

As shown in step 360, these steps are repeated until all the hops have been checked.

Concluding Remarks

These embodiments described, after a failure in the network, can allow a faster rerouting of circuits. This is possible because a simple evaluation performed at the ingress of a circuit can avoid delays caused by starting a distributed signalling procedure whose failure is very probable. In the case of circuits with many alternate paths a path with high probability of success can be chosen instead of choosing randomly or using a static priority that cannot keep count of the available resources on the network.

This can therefore increase the performance of signalling procedures avoiding risky paths. Behaving in this way it is possible to have a shorter traffic disruption in case of network failure. This can satisfy more easily the Service Level Agreement negotiated by an operator with the final customer.

Other variations and embodiments can be envisaged within the claims.

1. A node for a telecommunications network, the node comprising a switch and a controller using Generalized Multiprotocol Label Switching (GMPLS) protocol, the controller being arranged to carry out a set up procedure for setting up a circuit along a main path through nodes of the network, and the circuit having associated with it one or more precalculated alternate paths for the circuit, stored so that the controller can set them up in the event of failure of the main path;
the controller further arranged to respond to an indication of failure of the main path for the circuit by causing a check to be made of whether one or more of the precalculated alternate paths is currently valid, based on whether network resources needed by the one or more alternate paths are currently available, according to a local dynamically updated routing database; and
the controller further arranged to set up the switch and to communicate with other nodes using the GMPLS protocol to set up one of the alternate paths for that circuit based on an outcome of the check.

2. The node of claim 1, the controller is further arranged to select one of the alternate paths in response to the indication of failure of the main path, and to carry out the check on the selected alternate path before rerouting the circuit along the selected alternate path.

3. The node of claim 1, further comprising a path calculation element, arranged to generate the precalculated alternate paths.

4. The node of claim 1, having within the node the local dynamically updated routing database for indicating current availability of resources of the network.

5. The node of claim 1, further comprising a validity checking part, arranged to access the local dynamic updated routing database to carry out the check of the validity.

6. The node of claim 1, further comprising a protocol controller to carry out the set up procedure using a distributed signaling procedure with neighboring nodes.

7. The node of claim 6, wherein the distributed signaling comprises a Resource Reservation Protocol (RSVP) protocol and circuits comprising label switched paths.

8. The node of claim 1, wherein the node is a node of an automatically switched optical network, and the alternate paths comprise one or more optical paths, and the rerouting is carried out on an end to end basis.

9. The node of claim 1, wherein the node is a node of a synchronous network, and the switch comprising an electrical domain switch.

10. The node of claim 3, wherein the path computation element is arranged to recalculate the precalculated alternate paths periodically.

11. The node of claim 3, wherein the path computation element is arranged to generate a further alternate path if the check indicates that the alternate paths are not currently valid.

12. A method of operating a node for a telecommunications network, the node using Generalized Multiprotocol Label Switching (GMPLS) protocol and having a switch, the method comprising:
setting up a circuit along a main path through nodes of the network, the circuit having one or more precalculated alternate paths for the circuit, stored locally, for use in an event of failure of the main path;
responding to an indication of failure of the main path for the circuit by causing a check to be made of whether one or more of the precalculated alternate paths is currently valid, based on whether the network resources needed by the one or more alternate paths are currently available, according to a local dynamically updated routing database; and
setting up the switch and communicating with other nodes using the GMPLS protocol to set up one of the alternate paths for that circuit based on an outcome of the check.

13. The method of claim 12, further comprising selecting one of the alternate paths in response to the indication of failure of the main path, and carrying out the check on the selected alternate path before rerouting the circuit along the selected alternate path.

14. The method of claim 12, further comprising generating the precalculated alternate paths at the node.

15. The method of any of claims 12, wherein the local dynamically updated routing database indicates current availability of resources of the network being located within the node.

16. The method of any of claims 12, wherein checking the validity performed within the node.

17. The method of any of claims 12, wherein setting up the alternate path involves using a distributed signaling procedure with neighboring nodes.

18. The method of claim 17, wherein the distributed signaling procedure comprises a Resource Reservation Protocol (RSVP) protocol and the setting up of the paths comprises setting up label switched paths.

19. A non-transitory computer-readable medium having computer instructions stored therein, which when executed by a node for a telecommunications network, the node using Generalized Multiprotocol Label Switching (GMPLS) protocol and having a switch, cause the node to perform operations comprising:
setting up a circuit along a main path through nodes of the network, the circuit having one or more precalculated alternate paths for the circuit, stored locally, for use in an event of failure of the main path;
responding to an indication of failure of the main path for the circuit by causing a check to be made of whether one or more of the precalculated alternate paths is currently valid, based on whether network resources needed by the one or more alternate paths are currently available, according to a local dynamically updated routing database; and
setting up the switch and communicating with other nodes using the GMPLS protocol to set up one of the alternate paths for that circuit based on an outcome of the check.
